(19) United States
(12) Patent Application Publication
(10) Pub. No.: US 2021/0112146 A1
(43) Pub. Date: Apr. 15, 2021

(54) Data Processing and Transmission Method

(71) Applicant: VOLKAN SEVINDIK, PARKER, CO (US)

(72) Inventor: VOLKAN SEVINDIK, PARKER, CO (US)

(21) Appl. No.: 16/751,271

(22) Filed: Jan. 24, 2020

Related U.S. Application Data
(60) Provisional application No. 62/796,570, filed on Jan. 24, 2019.

(51) Int. Cl. H04L 29/06; H04L 29/08; G06F 8/65

(52) U.S. Cl. CPC H04L 69/03; H04L 69/02; H04L 67/10; H04L 67/34; G06F 8/65; H04L 69/08

(57) ABSTRACT

New data processing and transmission method is disclosed. A node executing at least one of protocol layer software downloads software from protocol software server. Each node in network has a node type associated with it and node type is defined by the protocol software layer that node executes. Protocol layer selector selects the protocol layer software running in a node. Communication starts when protocol completion is achieved, and protocol completion is achieved when combination of nodes executes all protocol layers of communication standard.

### CROSS REFERENCE TO A RELATED APPLICATION

This application claims the benefit of U.S. Provisional Application Ser. No. 62/796,570, filed 24 Jan. 2019, the disclosure of which is hereby incorporated by reference in its entirety, including all figures, tables, and drawings.

### BACKGROUND OF THE INVENTION

Wireless service providers have been looking for ways to decrease capital and operational expenditures of base station deployment. Today, each base station or base band unit is placed on the top of a building to provide coverage, and base station is connected to core network through a cable connection. In this deployment model, each base station or base band unit has at least one antenna connected to itself, and for deployment location of base station, service providers pay rent. There will also be cost associated with cooling, heating, and electricity. Once deployed base station has operational cost of rent, electricity, backhaul, software upgrades, maintenance, optimization, personnel, and engineering.

Capital expenditures of network deployment comprising at least one of hardware and software cost of base station, hardware and software cost of antennas, hardware cost of cabling, connectors, ports and other hardware that is needed to run base station.

In order to reduce capital and operational expenditures, service providers started deploying cloud-based radio access network or cloud radio access network (CRAN). In CRAN network architecture, base band units are located in the center of network and center is the data center. In order words, base band units are placed far from antennas which are placed at the top of the buildings. Since base band unit is centrally located, there will not be any cost associated with real state rent, cooling, heating, electric consumption and backhaul. Moreover, since base band unit is located in a data center, software upgrades, tests, feature upgrades are easily being done. In CRAN network architecture, base band unit is called Central Unit (CU) and unit that is placed next to antenna is called Distributed Unit (DU). Different parts of communication standard are executed in CU and DU, which is called split options. For instance, split 7 means physical layer of communication standard runs in DU and other layers run in CU. Split option 2 refers to a model where first 3 protocol layers of communication standard runs in DU and other layers of communication standard run in CU. By splitting the protocol layers of communication standard between DU and CU, certain data transmission delay/latency and throughput requirements are met.

### BRIEF DESCRIPTION OF THE DRAWINGS

FIG. 1 shows hardware components of node and central unit.

FIG. 2. shows hardware components of protocol software server.

FIG. 3 shows software components of a node and central unit running on hardware components in FIG. 1.

FIG. 4 shows software components of protocol software server running on hardware components in FIG. 2.

FIG. 5 shows core network components of 4G/LTE evolved packet core.

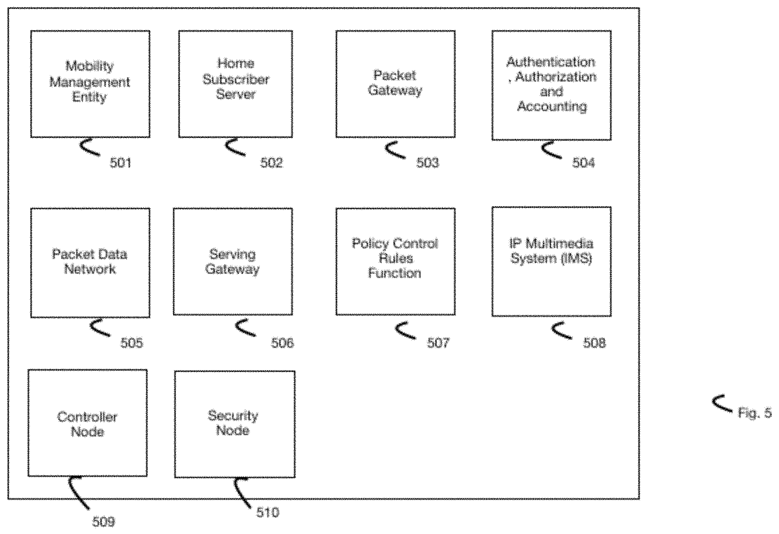

FIG. 6 shows core network components of 5G Core network.

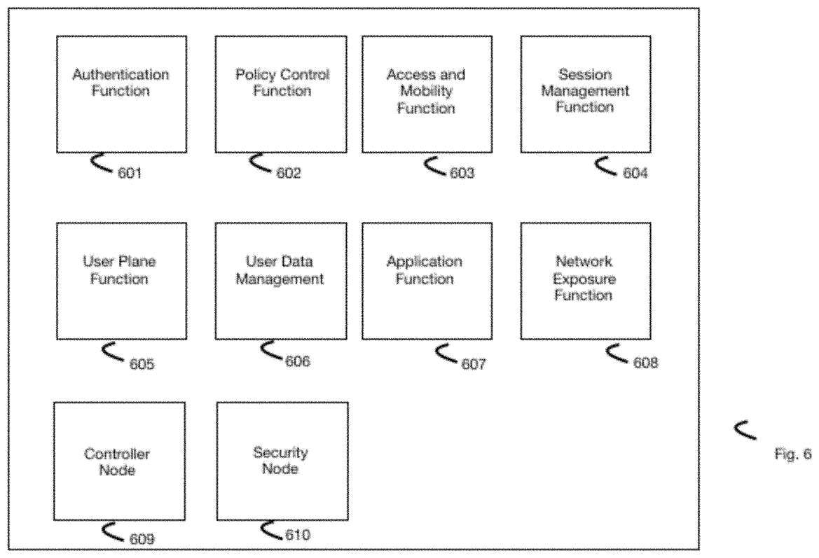

FIG. 7 shows hardware components for remote radio head.

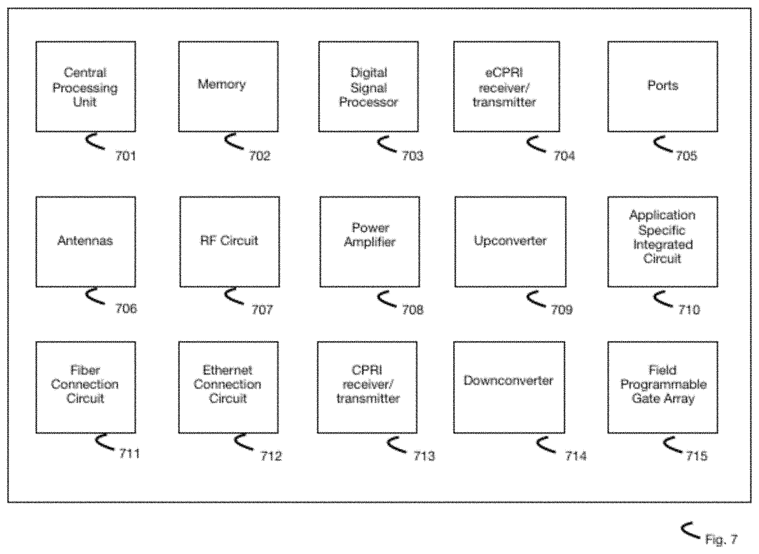

FIG. 8 shows software components of remote radio head running on remote radio head hardware in FIG. 7.

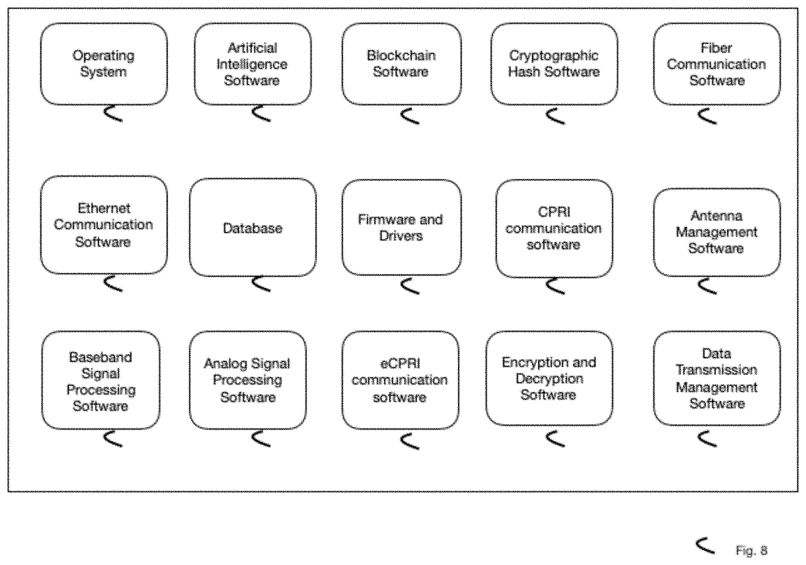

FIG. 9 shows nodes with different identifiers, remote radio head, core network and connections between them.

FIG. 10 shows nodes with different identifiers, remote radio head, core network and wired and wireless connections between them.

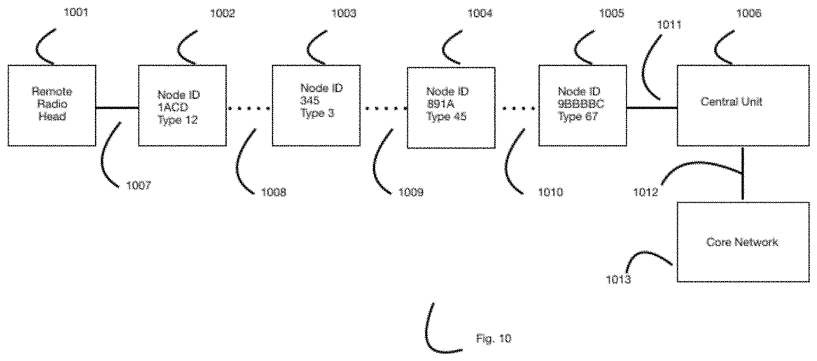

FIG. 11 shows two nodes with different identifiers talking with each other to exchange information.

FIG. 12 shows protocol software server connected to different nodes with different identifiers.

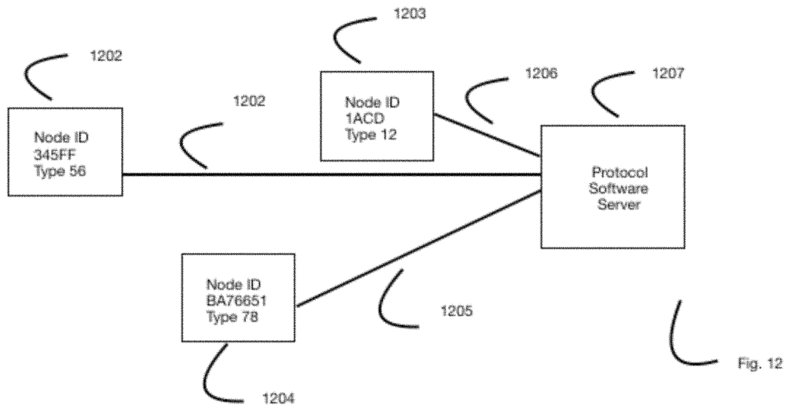

FIG. 13 shows protocol scheduler software located inside of protocol software server.

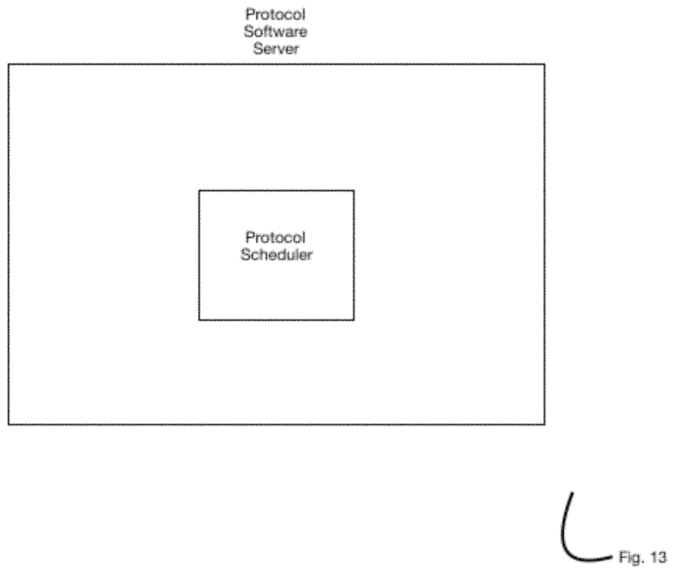

FIG. 14 shows nodes with different types, remote radio head, core network and connections between them.

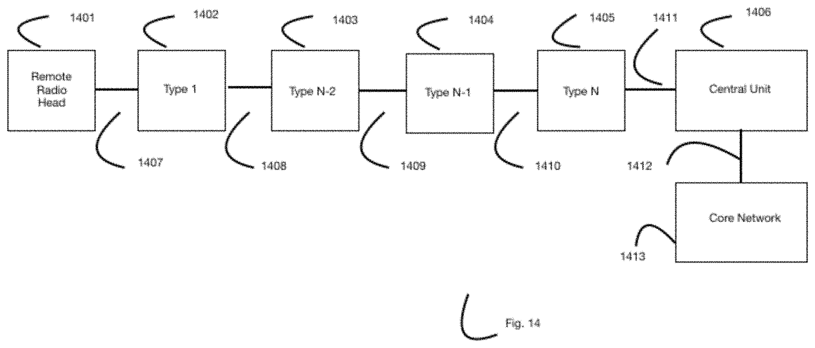

FIG. 15 shows nodes with different types, nodes with types converted, remote radio head, core network and connections between them.

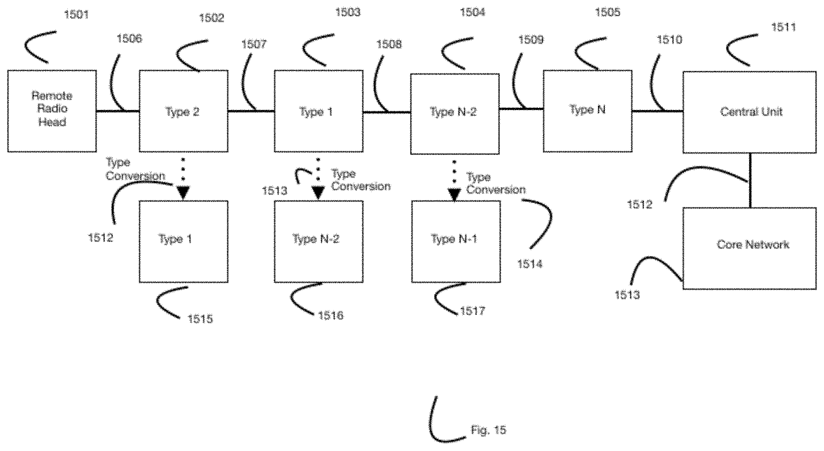

FIG. 16 shows protocol layers of a communication standard, technique or method.

FIG. 17 shows table showing different types of nodes, inbound link capacity of each node, outbound link capacity of each node, location of each node, inbound link latency of each node, outbound link latency of each node.

FIG. 18 shows protocol layer converter, node and type conversion messaging between protocol layer converter and node.

FIG. 19 shows protocol layer software converter, node, and protocol layer upgrade messaging between protocol layer software server and node,

FIG. 20 shows protocol layer software server, node, and protocol layer software test messaging between protocol layer software server and node.

FIG. 21 shows protocol layer converter as part of a node.

FIG. 22 shows three nodes with different identifications but with the same types.

FIG. 23 shows three nodes with one node being different node type.

FIG. 24 shows three nodes each with a different node type.

FIG. 25 shows core network, three nodes with different types and remote radio head.

FIG. 26 shows user terminals, remote radio heads communicating with user terminals, nodes and core network connected.

FIG. 27 shows a blockchain.

### BRIEF SUMMARY OF THE INVENTION

In CRAN network architecture, depending on split model, different protocol layers are executed/run in DU and CU. This disclosure introduces a novel technique of splitting protocol layers between nodes in the network. Each node in the network can execute different protocol layers at different times depending on requirements. Node type concept is disclosed which means each node has a certain type depending on protocol layer or protocol layers that node executes. Also, a node can change its type at any time if needed, or protocol converter can change node's type at anytime depending on certain conditions and triggering events.

Protocol completion concept is introduced which means a set of nodes through which data passes through implements all protocol layers of a communication standard that is used to for communication in a network. For the sake of protocol completeness, a node can change its node type.

Protocol software server hosts software for all protocol layers of a communication standard, and shares a protocol layer or protocol layers with a node upon request from a node. Node can download any protocol layer from protocol software server at any time. Protocol software server can also upgrade software of protocol layers of communication standard, test the software, debug the software, troubleshoot the software.

### DETAILED DESCRIPTION

Reference is now made to the drawings wherein like numerals refer to like parts throughout.

As used herein, the term “node” refers generally and without limitation to a network node which enables communication between a user or client device and another entity within a network, such as for example a cellular NB, a cellular eNB, eNB New Radio, a Wi-Fi AP, Bluetooth Node, Satellite Node or a Wi-Fi-Direct enabled client or other device acting as a Group Owner (GO).

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could include a downloadable Java Xlet™ that runs within the JavaTV™ environment.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terms “client device” or “user device” or “UE” include, but are not limited to, set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, smartphones, and vehicle infotainment systems or portions thereof.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “headend” or “backend” refers generally to a networked system controlled by an operator (e.g., an MSO) that distributes programming to MSO clientele using client devices. Such programming may include literally any information source/receiver including, inter alia, free-to-air TV channels, pay TV channels, interactive TV, over-the-top services, streaming services, and the Internet.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “LTE” refers to, without limitation and as applicable, any of the variants or Releases of the Long-Term Evolution wireless communication standard, including LTE-U (Long Term Evolution in unlicensed spectrum), LTE-LAA (Long Term Evolution, Licensed Assisted Access), LTE-A (LTE Advanced), and 4G/4.5G LTE.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), 3D memory, and PSRAM.

As used herein, the terminology “computer” or “computing device” includes any unit, or combination of units, capable of performing any method, or any portion or portions thereof, disclosed herein. For example, the “computer” or “computing device” may include at least one or more processor(s).

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein the terms “5G” and “New Radio (NR)” refer without limitation to apparatus, methods or systems compliant with 3GPP Release 15, and any modifications, subsequent Releases, or amendments or supplements thereto which are directed to New Radio technology, whether licensed or unlicensed.

As used herein the terms “4G” and “4G eNB” refer without limitation to apparatus, methods or systems compliant with 3GPP Release 8, and any modifications, subsequent Releases, or amendments or supplements thereto which are directed to New Radio technology, whether licensed or unlicensed.

As used herein the terms “5G Core” and “Core Network” refer without limitation to apparatus, methods or systems compliant with 3GPP Release 15, and any modifications, subsequent Releases, or amendments or supplements thereto which are directed to Core Network technology.

As used herein the terms “4G Core” and “Evolved Packet Core (EPC)” refer without limitation to apparatus, methods or systems compliant with 3GPP Release 8, and any modifications, subsequent Releases, or amendments or supplements thereto which are directed to Core Network technology, whether licensed or unlicensed.

As used herein, the terms “network” and “bearer network” refer generally to any type of telecommunications or data network including, without limitation, satellite networks, telco networks, data networks (including WANs, MANs, LANs, WLANs, intranets, and internets), and hybrid fiber coax (HFC) networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., 3GPP, 3GPP2, LTE/LTE-A/LTE-U/LTE-LAA, 5G NR, SONET, Frame Relay, DOCSIS, IEEE Std. 802.3, ATM, X.25, WAP, SIP, UDP, FTP, RTP/RTCP, H.323, etc.).

As used herein, the term “network interface” refers to any signal or data interface with a component or network including, without limitation, those of the USB (e.g., USB 2.0, 3.0. OTG), FireWire (e.g., FW400, FW800, etc.), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), LTE/LTE-A/LTE-U/LTE-LAA, Wi-Fi (802.11), WiMAX (802.16), Z-wave, PAN (e.g., 802.15), or power line carrier (PLC) families.

As used herein, the term “server” refers to any computerized component, system or entity regardless of form which is adapted to provide data, files, applications, content, or other services to one or more other devices or entities on a computer network.

As used herein, the term “storage” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “Wi-Fi” refers to, without limitation and as applicable, any of the variants of IEEE Std. 802.11 or related standards including 802.11 a/b/g/n/s/v/ac/ad/ax or 802.11-2012/2013, 802.11-2016, as well as Wi-Fi Direct (including inter alia, the “Wi-Fi Peer-to-Peer (P2P) Specification”, incorporated herein by reference in its entirety).

As used herein, the term “wireless” means any wireless signal, data, communication, or other interface including without limitation 3GPP/3GPP2, Wi-Fi, Bluetooth/BLE, HSDPA/HSUPA, TDMA, CBRS, CDMA (e.g., IS-95A, WCDMA, etc.), FHSS, DSSS, GSM, PAN/802.15, WiMAX (802.16), 802.20, Zigbee®, Z-wave, narrowband/FDMA, OFDM, PCS/DCS, LTE/LTE-A/LTE-U/LTE-LAA, 5G NR, LoRa, IoT-NB, SigFox, analog cellular, CDPD, satellite systems, millimeter wave or microwave systems, acoustic, and infrared (i.e., IrDA).

As used herein, the term “base station” refers to any 3GPP-compliant node including without limitation eNBs (eUTRAN) and gNBs (5G NR).

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

For simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical similar devices, systems, compositions and methods. Those of ordinary skill may thus recognize that other elements and/or steps may be desirable or necessary to implement the devices, systems, compositions and methods described herein. However, because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Users, subscribers, user terminals, user equipment, mobile phones terms have the same meaning and they are used interchangeably in this disclosure. Communication standard, communication standard, communication software terms have the same meaning, and they are used interchangeably in this disclosure. Protocol layer, protocol layer software, software of protocol layer terms have the same meaning, and they are used interchangeably in this disclosure.

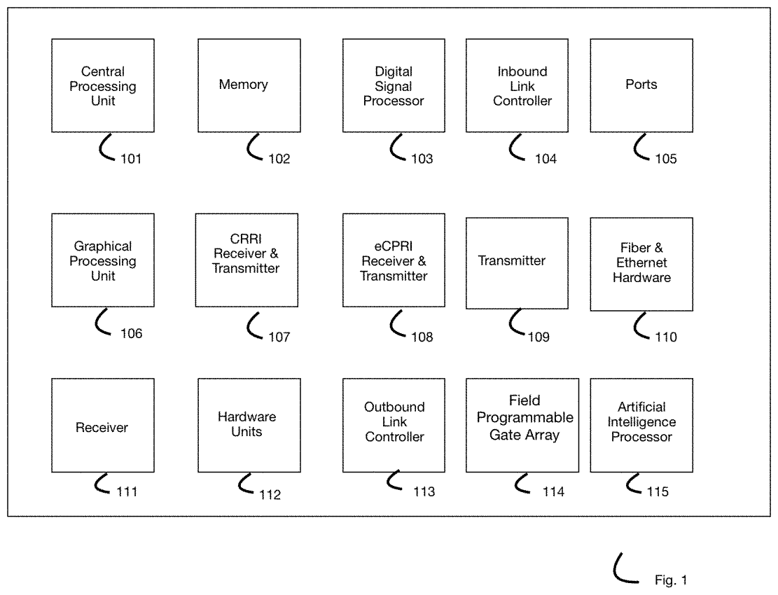

Node hardware (FIG. 1) comprising at least one of central processing unit 101, memory 102, digital signal processor 103, inbound link controller 104, ports 105, graphical processing unit 106, CPRI receiver & transmitter 107, eCPRI receiver & transmitter 108, transmitter 109, fiber/ethernet hardware 110, receiver 111, hardware units 112, outbound link controller 113, field programmable gate array 114, artificial intelligence processor 115. A Node can have at least one of these hardware components.

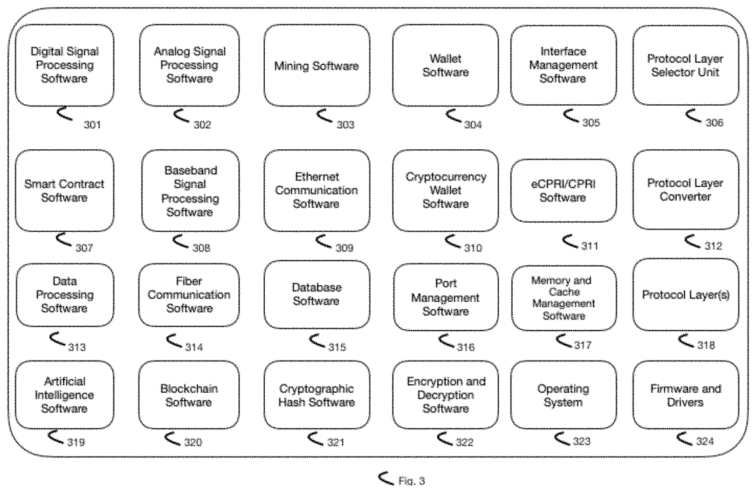

Node software (FIG. 3) comprising at least one of digital signal processing software 301, analog signal processing software 302, mining software 303, wallet software 304, interface management software 305, protocol layer selector unit 306, smart contract software 307, baseband signal processing software 308, ethernet communication software 309, cryptocurrency wallet software 310, eCPRI & CPRI software 311, protocol layer converter 312, data processing software 313, fiber communication software 314, database software 315, port management software 316, memory and cache management software 317, protocol layer(s) 318, artificial intelligence software 319, blockchain software 320, cryptographic hash software 321, encryption and decryption software 322, operating system 323, firmware and drivers 324.

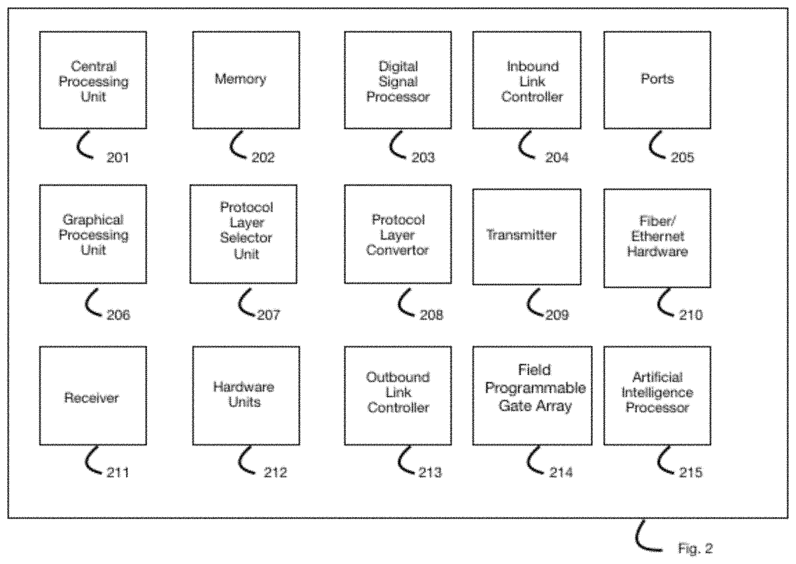

Protocol server hardware (FIG. 2) comprising at least one of central processing unit 201, memory 202, digital signal processor 203, inbound link controller 204, ports 205, graphical processing unit 206, protocol layer selector unit 207, protocol layer convertor 208, transmitter 209, fiber/ethernet hardware 210, receiver 211, hardware units 212, outbound link controller 213, field programmable gate array 214, artificial intelligence processor 215.

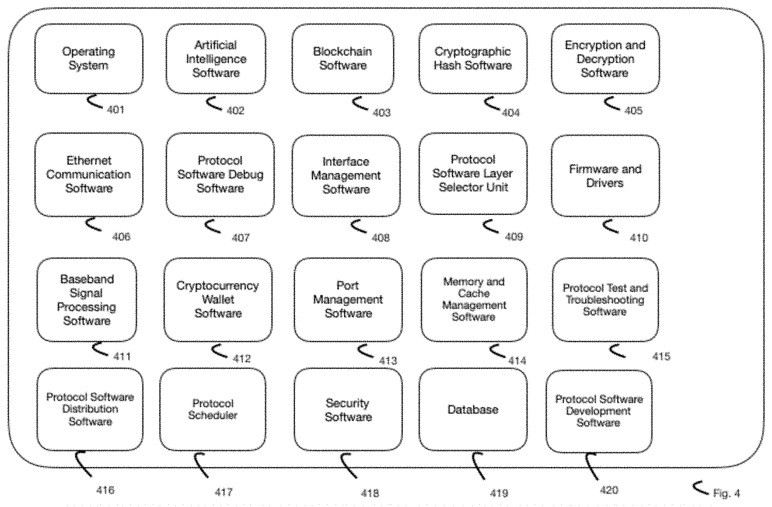

Protocol server software (FIG. 4) comprising at least one of operating system 401, artificial intelligence software 402, blockchain software 403, cryptographic hash software 404, encryption and decryption software 405, ethernet communication software 406, protocol software debug software 407, interface management software 408, protocol software layer selector unit 409, firmware and drivers 410, baseband signal processing software 411, cryptocurrency wallet software 412, port management software 413, memory and cache management software 414, protocol test and troubleshooting software 415, protocol software distribution software 416, protocol scheduler 417, security software 418, database 419, protocol development software 420.

Node and network node have the same meaning and these terms are used interchangeably in this disclosure. Protocol completion, protocol completeness, complete protocol chain, protocol chain terms have the same meaning and these terms are used interchangeably in this disclosure.

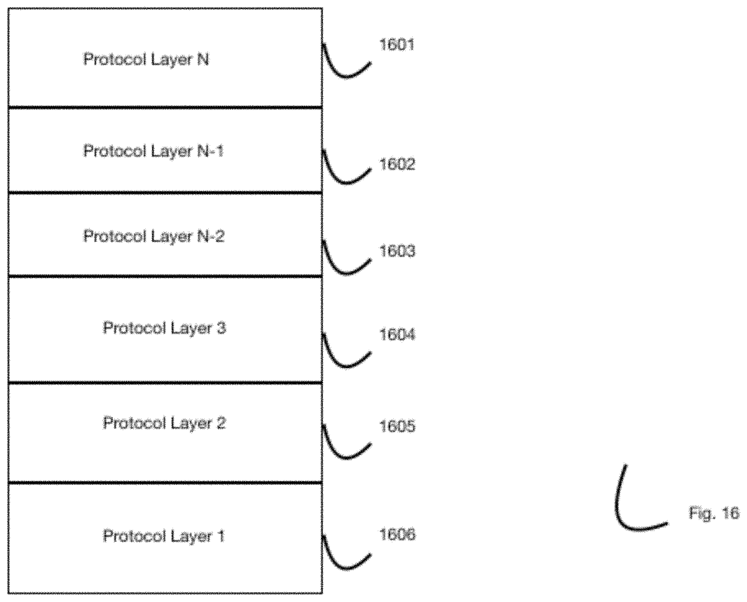

Protocol layer software (FIG. 16) is a software that runs particular task or tasks assigned to itself. There are single layer communication standards, or multiple layer communication standards 1601, 1602, 1603, 1604, 1605, 1606. Each layer of communication standard performs specific tasks of a communication standard which can be 3G cellular communication standard, 4G cellular communication standard, 5G communication standard, 802.11 communication standard. Protocol completion means all protocol layers of communication standard is executed by a node or a set of nodes together.

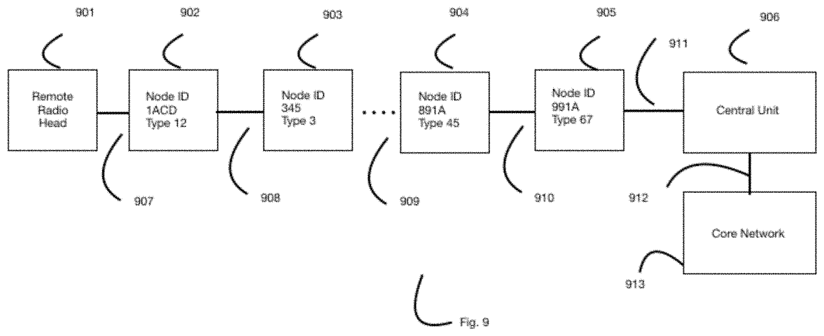

Protocol completion is an event that occurs when a node or number of nodes can run all protocol layers required by communication standard. Protocol completion has to be accomplished in order to send data to subscribers in network and protocol completion has to be accomplished in order to receive data from subscribers in network. If there is no protocol completion in network, service will be interrupted, and service will be resumed when protocol completion is achieved. FIG. 9 shows four different nodes with different types 902, 903, 904, 905, remote radio head 901, central unit 906 and core network 913. Node 902 is type12 which means node executes protocol layer 1 and protocol layer 2. Node 903 is type3 which means node executes protocol layer 3. Node 904 is type45 which means node executes protocol layer 4 and protocol layer 5. Node 905 is type67 which means node executes protocol layer 6 and protocol layer 7. If communication standard has 7 protocol layers, then this node combination of 902, 903, 904, and 905 achieves protocol completion which means central unit can send data remote radio head, and remote radio head can send data to central unit. Central unit can be a standalone unit, or central unit can be part of core network.

Different nodes 902, 903, 904, 905, 1002, 1003, 1004, 1005 in the network run same or different number of protocol layers.

Nodes in the network run at least one layer of the protocol. Nodes in the network communicate with each other with at least one of wireless 909, 1008, 1009, 1010, wired 908, 910, or fiber communication lines, 908, 910.

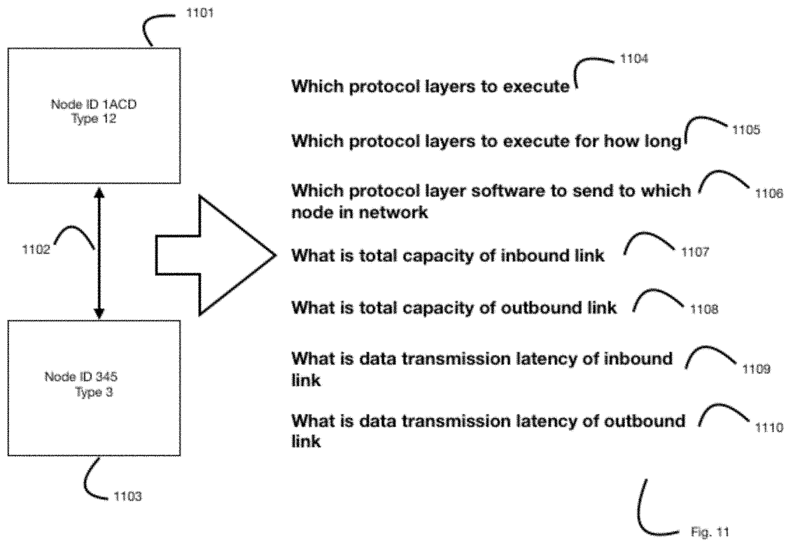

Nodes 1101, 1103 in the network direct 1102 each other on (FIG. 11) at least one of;
Which protocol layers to execute 1104,
Which protocol layers to execute for how long 1105,
Which protocol layer software to send to which node in network 1106,
What is total capacity of inbound link 1107,
What is total capacity of outbound link 1108,
What is data transmission latency of inbound link 1109,
What is data transmission latency of outbound link 1110.

There is protocol software server that sends full copy or part of copy of communication standard protocol to at least one of nodes in network. Protocol software server holds all different releases of communication software for communication standard. Protocol software server upgrades software based on the latest wireless and wired network communication standards. Protocol software server 1207 stores, distributes, upgrades all protocol layers of communication standard. Each node in network 1202, 1203, 1204 can download any protocol layer from protocol server, and each node in network can also upload its protocol layer to protocol server for troubleshooting. Protocol server 1207 distributes a single protocol layer, a set of protocol layers, or all protocol layers to a node, a set of nodes, or all nodes in network. Protocol server upgrades software of a single protocol layer, a set of protocol layers or all protocol layers of communication standard. For any new protocol software, protocol server performs certain tests, a group of tests, fix any issues in the software, and debug the software.

Protocol software server hosts protocol scheduling component; however protocol scheduling component can run in any node in network.

There are different types of nodes 1402, 1403, 1404, 1405, 1502, 1503, 1504, 1504 in network, and type is defined by protocol layer executed/run by node. For example, if node runs layer 1 of communication standard, this node is called type1 node, if node runs layer 2 of communication standard, this node is called type2 node, if node runs layer 3 of communication standard, this node is called type3 node, if node runs layer 4 of communication standard, this node is called type4 node, if node runs layer 5 of communication standard, this node is called type5 node, if node runs layer 6 of communication standard, this node is called type6 node, if node runs layer 7 of communication standard, this node is called type7 node, if node runs layer 1 and layer 2 of communication standard, this node is called type12 node, if node runs layer 2 and layer 3 of communication standard, this node is called type23 node, if node runs layer N and layer N−1 of communication standard, this node is called type (N−1) (N), if node runs layer N and layer N+1 of communication standard, this node is called type (N)(N+1), if a node runs layer N−1, N, N+1 of communication standard, this node is called type (N−1)(N)(N+1) and so on.

In order to transmit data to a user, data has to pass through a series of nodes, total of which should run all layers of communication standard. For instance, if communication standard consists of 7 layers; then subscriber data has to pass through node type 1, node type 2, node type 3, node type 4, node type 5, node type 6, node type 7; or node type 12, node type 34, node type 56, node type 7; or any combination of nodes that run all protocol layers of communication standard.

Protocol scheduler will perform at least one of tasks;
Make decision on which node(s) in network run(s) which version of communication standard,
Make decision on which node(s) in network run(s) which layer(s) of communication standard,
Make decision on which node(s) in network run(s) which layer(s) of communication standard for how long,
Make decision on series of nodes that transmit the data to subscribers.

In order to make decision, protocol scheduler uses at least one of;
Which node runs which protocol layer;
Which node runs which protocol layers;
Which nodes run which protocol layer;
Which nodes run which protocol layers;
Capacity of inbound and outbound communication links of node;
Capacity of inbound and outbound communication links of nodes;
Data latency of inbound and outbound communication links of node;
Data latency of inbound and outbound communication links of nodes;
Which nodes are located in the edge of network;
Which nodes are located in the center of network;
Which nodes are located between edge and center of network;
Type of traffic transmitted to subscribers;
Amount of traffic transmitted to subscribers;
Quality of service level of traffic sent to subscribers;
Number of subscribers in network;
Number of nodes in network;
Type of nodes in network;
Computing capacity of a node;

Number of nodes that run whole protocol layers of communication standard are pre-defined, or created in real time.

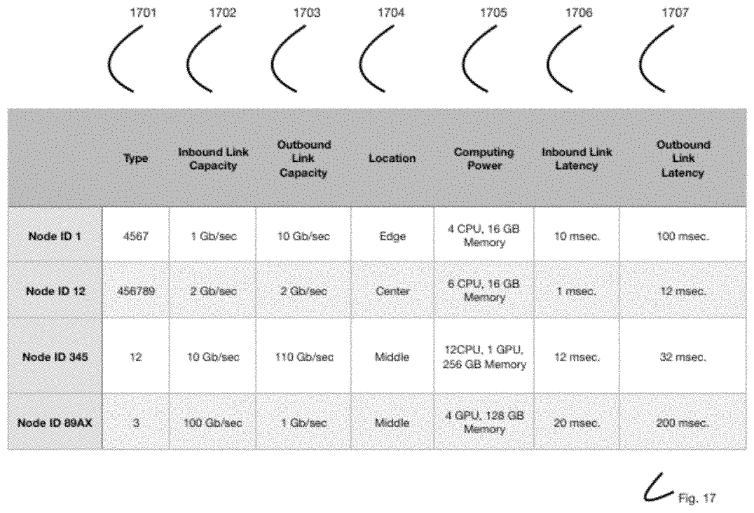

Protocol scheduler holds table (FIG. 17) that has information about nodes, node types 1701, node location 1704, node computing power 1705, inbound communication link latency 1706, outbound communication link latency 1707, inbound communication link capacity 1702, outbound communication link capacity 1703.

Node (FIG. 1) computing power is combination of at least one of;
Number of central processing units,
Number of central processing unit cores;
Amount of memory units;
Amount of available memory;
Number of graphical processing units;
Number of field programmable gate arrays;
Number of inbound communication ports;
Number of outbound communication ports;
Energy source (battery, outlet, solar, or any combination)

Each node holds table that has type information of all other nodes in network. Each node in network knows type of other nodes in network.

As in shown in figure, all nodes executing the protocols should run all required protocol layers of communication standard when all nodes combined. Communication standard is standard used in communication network to enable communication between participating parties. It can be any communication standard including wireless, and wired.

Each node in network knows type of other nodes in network; and adjust type of itself based on type of other nodes in network. Each node in network searches for next node that supports different protocol layers than itself. For instance, node type 1 searches for node whose type is not type 1 for protocol completion. Node type 1 searches for node whose type is type 2, type 23, type 234, type2345, type 23456, type234567 for communication standard consisting of seven protocol layers.

One node type can change based on at least one of;
If protocol completion cannot be accomplished
If all nodes running same protocol layer
If nodes nearby running same protocol layer
If protocol completion can not be achieved with nodes running nearby
If node running particular protocol layer malfunctions
If nodes running particular protocol layers malfunction
Computing capability of node
Inbound communication link capacity of node
Outbound communication link capacity of node
Latency of inbound communication link
Latency of outbound communication link

When a node changes its type, node broadcasts ‘type update’ message to all nodes in network. All other nodes in network update their tables. ‘Type update’ message consists of ‘Node ID’, ‘Node Location’, ‘Node Current Type’, ‘How long node was in that current type’, ‘Node Inbound Communication Link Capacity’, ‘Node Outbound Communication Link Capacity’, ‘Node new type’, ‘Node Inbound Communication Link Latency’, ‘Node Outbound Communication Link Latency’.

Protocol layer convertor is used to convert type of a node. For instance, type2 node executes protocol layer 2; and it can be converted to type1 node which executes protocol layer 1. Each node has copy of all protocol layer software that is needed to communicate using communication standard. Each node can download any protocol layer or layers from protocol software server. Node only runs software protocol layer based on its type; that is, node type 1 only executes protocol layer 1; node type 2 only executes protocol layer 2, node type 3 only executes protocol layer 3, node type 4 only executes protocol layer 4, node type 5 only executes protocol layer 5, node type 6 only executes protocol layer 6, node type 7 only executes protocol layer 7, node type 12 only executes protocol layer 1 and layer 2, node type 123 only executes protocol layer 1, layer 2, and layer2; and so on.

Protocol layer selector is used to select which software protocol layer is executed on which node.

Software running in node can malfunction or can contain bugs. If software does not run properly, node can perform several techniques to resolve software issue;
Node can upload the protocol layer software to protocol server, and protocol server can fix any issues with it.
Node can fix software issues by itself through executing several test cases, and debugging methods.
Node can delete protocol software layer, and download new protocol software layer from protocol server.

Protocol chain starts with highest number protocol layer number N. Node nearest to core network runs protocol layer N (typeN node), and this node searches for node with protocol layer number N−1 (typeN−1 node), and node type N−1 (typeN−1 node) searches for node N−2 (typeN−2) and this process continues till protocol layer 1 (type1). If one node cannot find a node with a certain type, type of a current node is changed to the type needed. This change is done based on current type of node, type of node required, computing capacity of node, capacity of inbound and outbound links, latency of inbound and outbound links.

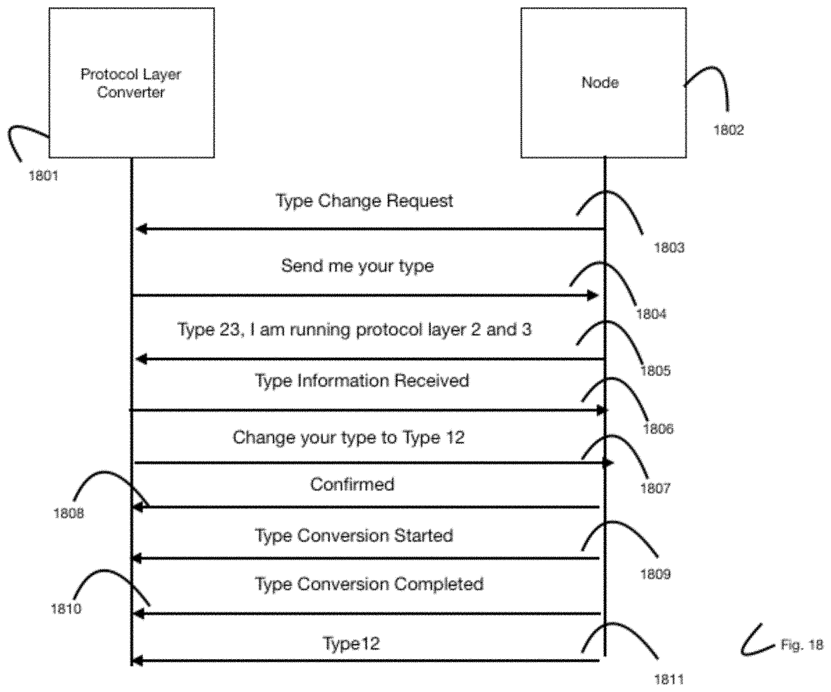

FIG. 18 shows messaging when a node 1802 wants to change its type. First a node 1802 sends ‘Type Change Request 1803’ message to protocol layer converter 1801, protocol layer converters responses with ‘Send me your type 1804’ message to the node, and node sends 1805 its current type back to protocol layer convertor. Protocol layer converter sends ‘Type Information Received 1806’ message back to node. Protocol layer converter directs 1807 node to change its type and also which type node should change to. Node confirms recipient, 1808 of this request. Node sends ‘Type Conversation Started 1809’ message back to protocol layer converter to confirm that the type conversion process has started. Node sends ‘Type Conversion Completed 1810’ message to Protocol layer converter to confirm that node completed the process of type conversion. Node sends its new type 1811 back to Protocol layer converter after conversion process is completed successfully.

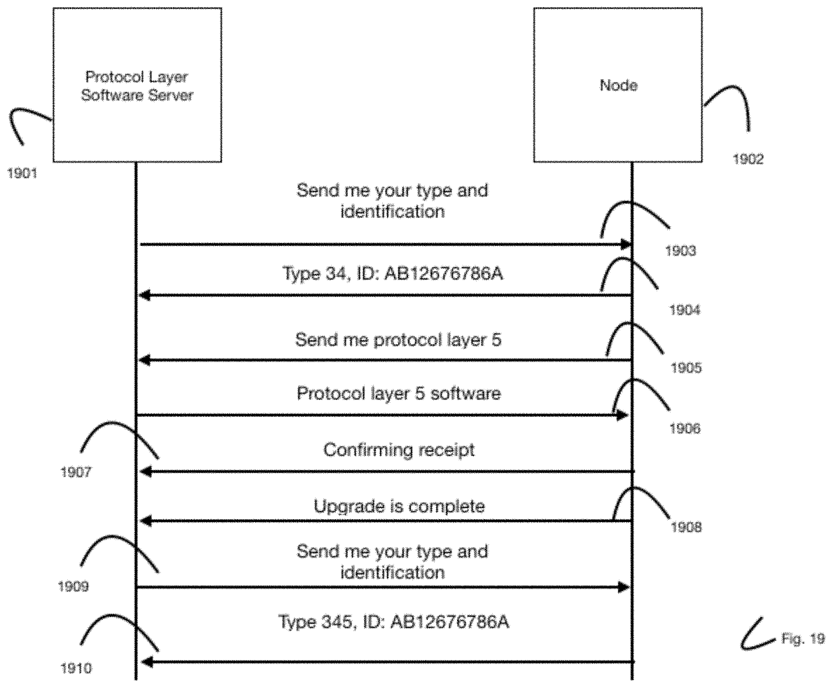

FIG. 19 shows the software upgrade process. First protocol layer software server 1901 sends ‘Send me your type and identification 1903’ message to a node, 1902. Second, node responds back to protocol layer software server with its type and identification, 1904. Third, node asks for the protocol software layer that node needs 1905. Fourth, protocol layer software server sends software of protocol layer that node asks 1906. Fifth, node confirms the receipt if node receives protocol layer software successfully 1907, otherwise node can ask for the same protocol layer software till node successfully receives protocol layer software. Once node upgrades itself with the new protocol layer software it has received from protocol later software server, a node sends ‘upgrade complete 1908’ message back to protocol layer software server. Then, protocol layer software server asks for node's type and identification 1909, and node responds back with is new type and the same identification 1910.

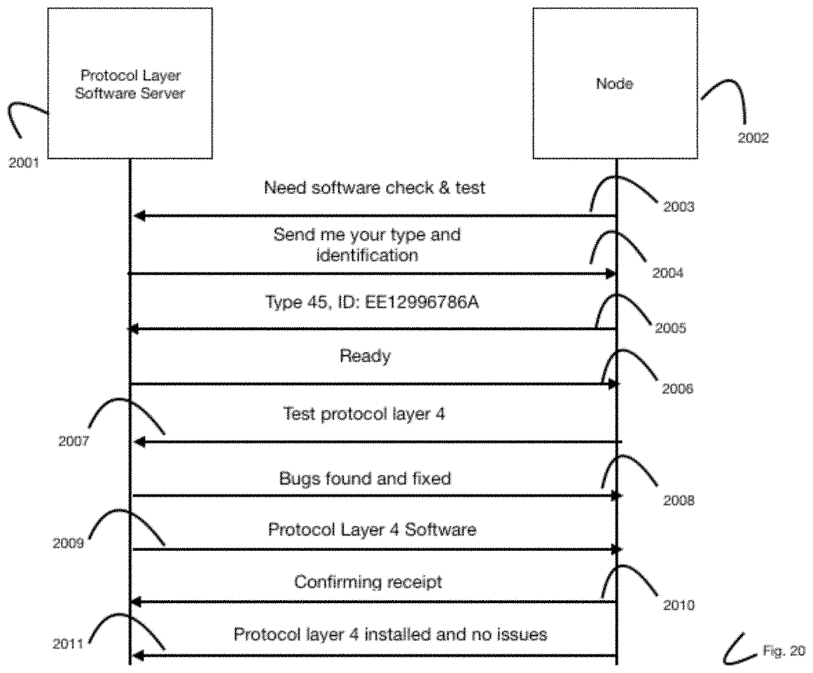

FIG. 20 shows the software debugging process. A node can run into issues with protocol layer(s) software it is executing. A node 2002 can ask from protocol layer software server 2001 to check and fix the issues with the protocol layer software. First node sends message ‘Need software check & test’ to protocol layer software server 2003. Protocol layer software server 2001 responds with ‘Send me your type and identification’ message 2004. Node sends its type and identification 2005 to Protocol layer software server. Protocol later software server sends ‘ready’ message 2006 to node. Node sends its needs by sending message 2007 that identifies the protocol layer that node wants Protocol layer software server to test. Protocol layer software server fixes all the bugs found in software code of protocol layer 4 and Protocol layer software server send ‘Bugs found and fixed 2008’ message to node. Protocol layer software server further sends new version of protocol layer 4 software 2009 to node. Node confirms successful recipient of protocol layer 4 software by sending ‘Confirming Receipt 2010’ message to protocol layer software server. Node receives new protocol layer software, installs the new software and sends message 2011 back to protocol layer software server.

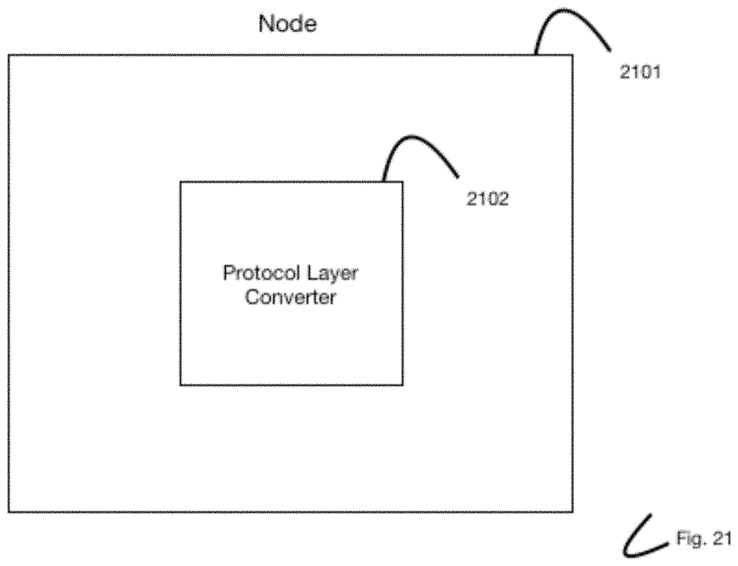

FIG. 21 shows protocol layer converter 2102 as part of node 2101. Protocol layer converter can be part of a node, can be part of protocol software server, or functions of protocol converter can be distributed over nodes in network.

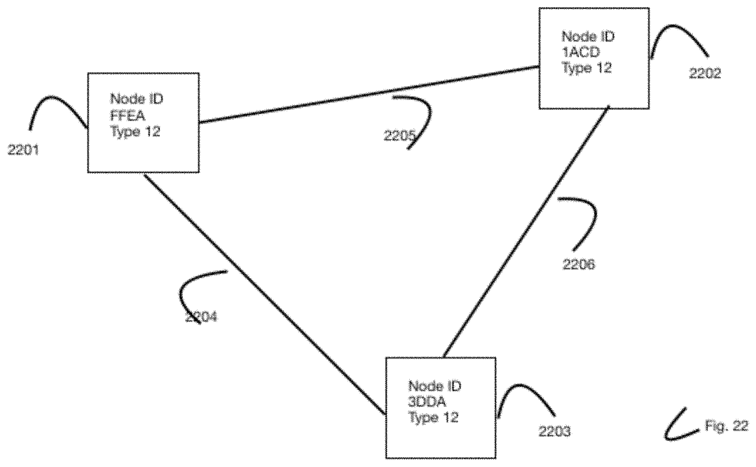

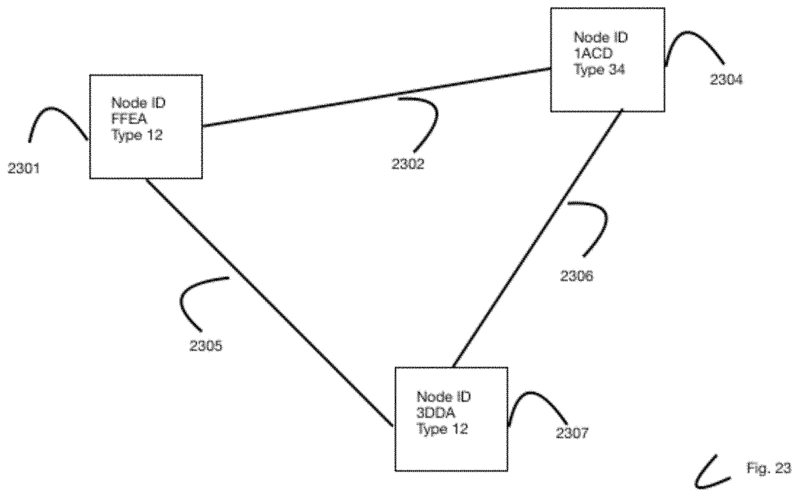

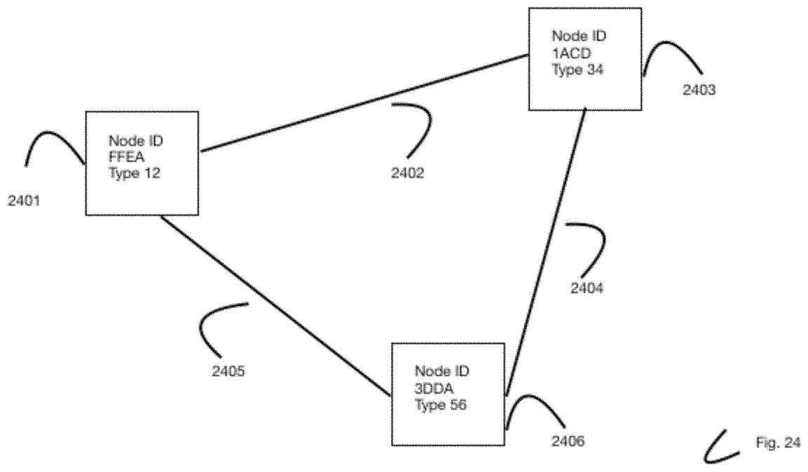

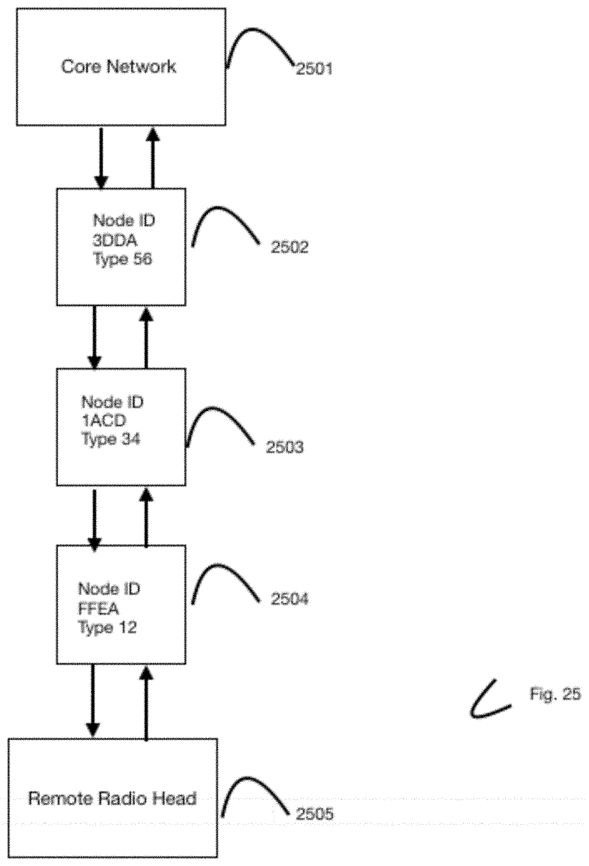

FIG. 22 show nodes 2201, 2202, 2203 with the same type connected to each other, and any kind of wired or wireless connection 2204, 2205, 2206 is used between nodes. When the same type of nodes is connected to each other, node can stay with the same types or nodes change their types. FIG. 23 shows that the type of Node ID IACD, 2304 has changed and new type of the node is type34. And FIG. 24 further shows that each node has different types now so that they can complete each other in terms of protocol layers they have to run in order to have complete protocol stack of a communication standard. If communication standard has 6 protocol layers, then, FIG. 25 shows that data packet from core network can be delivered to remote radio head by going through first node ID 3DDA 2502, second node ID IACD 2503, and third node ID FFEA 2504. Thus, three nodes can complete the protocol stack and data packet can be delivered to remote radio head. When a data packet is sent from remote radio head, data packet travels the same nodes in reverse order, 2504, 2503, 2502.

Protocol layer convertor, protocol software server, node, central unit and core network components record each data, transaction, and event in blockchain, which is an immutable chain of blocks. Data is recorded into blockchain by these mentioned nodes in any data, information or ledger format. These nodes can also be miners, the purpose of which are to create blocks in blockchain. However, blocks can also be created without any mining operation. In this disclosure, blocks are created by miners depending on at least one of;
Load of a miner, or available computing resources of a node, protocol layer converter, protocol server;
The speed of block generation;
The amount of data produced.
   Any type of consensus algorithm is used to record data in a block. Each miner node shares the exact copy of blockchain with other nodes in the network.

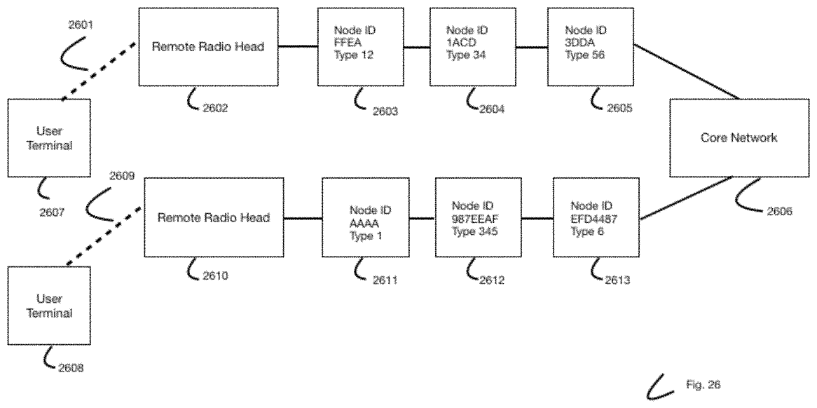

FIG. 26 shows user terminals communicating with remote radio heads which are connected to nodes with complete protocol layers sending data to remote radio heads and receiving data from remote radio heads.

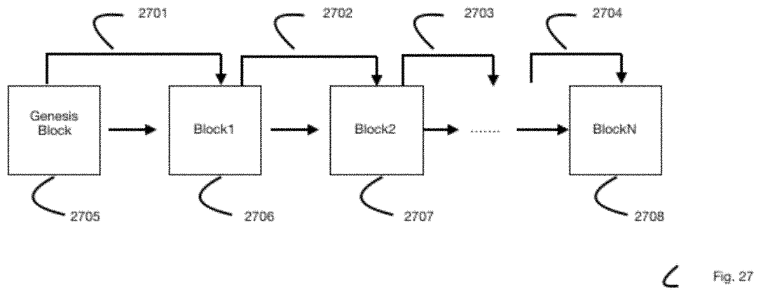

FIG. 27 shows blockchain in which each block is connected to each other through cryptographic hashing mechanism. Blockchain starts with genesis block.

What claimed is:

1- A new data processing and transmission method, the method comprising;
node executing at least one protocol layer of communication standard, and communicate with each other through wired or wireless communication links;
central unit that is connected to core network or data center, and nodes;
remote radio unit that sends and receives electromagnetic signals;
protocol software server that stores copy software of all protocol layers of communication standard;
protocol scheduler that makes decision on which nodes to execute which protocol layer software;
protocol layer convertor to change types of nodes;
protocol layer selector to select which protocol layer software to execute on a node;
protocol complete chain that contains a node or a set of nodes executing all protocol layers software of communication standard.

2- The method of communication between central unit to remote radio head, the method comprising:
selecting a node, by node, or a set of nodes that can together execute all protocol layers of communication standard;
converting type of node, by protocol converter, to another type in order to achieve protocol completeness;
upgrading software, by protocol software server, of a node to run different protocol layers of communication standard;
scheduling, by protocol scheduler, execution of different types of protocols running in different nodes;
testing and troubleshooting, by protocol software server, any issues with any protocol layer of communication standard;
downloading protocol layer software, by node, from protocol software server.

3- In claim 1 wherein said communication standard further means 3G, 4G/LTE, 5G NR, 802.11, Bluetooth standard or any wireless and cellular wireless communication standard.

4- In claim 1 wherein said node further consists of at least one of central processing unit, memory, digital signal processor, graphical processing unit, ports, CPRI receiver & transmitter, eCPRI receiver & transmitter, transmitter, fiber & ethernet communication hardware, field programmable gate array, artificial intelligence processor, inbound link controller, receiver, outbound link controller.

5- In claim 1 wherein said central unit is a node that receives data from core network and sends data to core network, and it can communicate with any type of node through wired link, or wireless link or any combination of both links.

6- In claim 1 wherein said node has a node type defined by the protocol layer software that it is executing.

7- In claim 1 wherein said protocol layer converter is part of a node, or it is part of protocol software server, or it is part of central unit, or it is part of core network or functions of it is distributed over nodes, central units, core network nodes, and remote radio heads in network.

8- In claim 1 wherein said protocol scheduler performs at least one of tasks of making decision on which node(s) in network executes which version of communication standard, making decision on which node(s) in network executes which protocol layer of communication standard, making decision on which node(s) in network executes which protocol layers of communication standard, making decision on which node(s) in network executes which protocol layer of communication standard for how long, making decision on which node(s) in network executes which protocol layers of communication standard for how long, making decision on series of nodes that transmit the data to subscribers.

9- In claim 1 wherein said protocol scheduler makes decision using at least one of which node executes which protocol layer, which node executes which protocol layers, which nodes execute which protocol layer, which nodes execute which protocol layers, capacity of inbound and outbound communication links of node, capacity of inbound and outbound communication links of nodes, data latency of inbound and outbound communication links of node, data latency of inbound and outbound communication links of nodes, which nodes are located in the edge of network, which nodes are located in the center of network, which nodes are located between edge and center of network, type of traffic transmitted to subscribers, amount of traffic transmitted to subscribers, quality of service level of traffic sent to subscribers, number of subscribers in network, number of nodes in network, type of nodes in network, computing capacity of a node.

10- In claim 1 wherein said protocol scheduler further contains a table that has information about nodes, node types, node location, node computing power, inbound communication link latency, outbound communication link latency, inbound communication link capacity, outbound communication link capacity.

11- In claim 1 wherein said protocol scheduler is part of protocol software server, or it is part of a node, or it is part of central unit, or it is part of core network, or functions of it is distributed over nodes, central units, core network nodes, remote radio heads.

12- In claim 1 wherein said node contains table that has type information of all other nodes in network.

13- In claim 1, wherein said node further performs at least of one the tasks if the protocol layer software it is executing does not function properly, node can upload the protocol layer software to protocol server which fixes any issues with it, node can fix software issues by itself through executing several test cases, and debugging methods, and node can delete protocol layer software, and node download new protocol layer software from protocol server.

14- In claim 1 wherein said protocol layer convertor further changes the type of node by selecting a different protocol layer software to be executed on the same node.

15- In claim 1, wherein said protocol software server further stores, distributes, upgrades all protocol layers software of communication standard, and protocol software server distributes a single protocol layer software, a set of protocol layers software, or all protocol layers software to a node, a set of nodes, or all nodes in network and protocol server upgrades software of a single protocol layer, a set of protocol layers or all protocol layers of communication standard.

16- In claim 1 wherein said protocol complete chain starts with the highest number protocol layer number N, and node nearest to core network executes protocol layer N (typeN node), and this node searches for node with protocol layer number N−1 (typeN−1 node), and node type N−1 (typeN−1 node) searches for node N−2 (typeN−2) and this process continues till protocol layer 1 (type1 node), and if one node cannot find a node with a certain type, type of a current node is changed to the type needed, and this change is done based on at least one of current type of node, type of node required, computing capacity of node, capacity of inbound and outbound links, latency of inbound and outbound links.

17- In claim 2 wherein said converting further means protocol converter directing at least one of the other nodes in network on which protocol layer(s) software to execute, which protocol layers software to execute for how long, which protocol layer software to send to which node in network, total capacity of inbound link, total capacity of outbound link, data transmission latency of inbound link, data transmission latency of outbound link.

18- In claim 6 wherein said node broadcasts ‘type update’ message to all other nodes in the network when type of node is changed.

19- In claim 6 wherein said node type changes based on at least one of conditions of if protocol completion cannot be accomplished, if all nodes running same protocol layer, if nodes nearby running same protocol layer software, if protocol completion cannot be achieved with nodes running nearby, If node running particular protocol layer software malfunctions, If nodes running particular protocol layers software malfunction, computing capability of node, inbound communication link capacity of node, outbound communication link capacity of node, latency of inbound communication link, latency of outbound communication link.

20- In claim 18 wherein said ‘type update’ message further consists of at least one of the message fields ‘Node ID’, ‘Node Location’, ‘Node Current Type’, ‘How long node was in that current type’, ‘Node Inbound Communication Link Capacity’, ‘Node Outbound Communication Link Capacity’, ‘Node new type’, ‘Node Inbound Communication Link Latency’, ‘Node Outbound Communication Link Latency’.
